(19) United States
(12) Patent Application Publication
(10) Pub. No.: US 2005/0149973 A1
(43) Pub. Date: Jul. 7, 2005

(54) Television with application/stream-specifiable language selection

(76) Inventor: Henry Y. Fang, Cerritos, CA (US)

Correspondence Address: MARGER JOHNSON & MCCOLLOM, P.C. - SHARP, 1030 SW MORRISON STREET, PORTLAND, OR, 97205, US

(21) Appl. No.: 10/962,814

(22) Filed: Oct. 7, 2004

Related U.S. Application Data
(60) Provisional application No. 60/535,115, filed on Jan. 6, 2004.

(51) Int. Cl. G06F 3/00; H04N 5/445; G06F 13/00; H04L 9/00; H04L 9/32; G06F 11/30; G06F 12/14

(52) U.S. Cl. 725/61

(57) ABSTRACT

Method and apparatus for use with televisions with multiple-language audio, text, and/or caption capability are included among the embodiments. In exemplary systems, a Java engine, Java manager, and Java applets exist in the system, and allow the user to customize language settings for different applets and/or media streams. Each applet and/or stream can be set to accept the default television settings or an individual setting stored in flash memory. Other embodiments are described.

This application claims priority from U.S. provisional patent application Ser. No. 60/535,115 filed Jan. 6, 2004, titled Television with Application/Stream-Specifiable Language Selection, which is incorporated herein in its entirety.

### FIELD OF THE INVENTION

This invention pertains generally to televisions, and more particularly to televisions with the capability to run Java applications and applets or similar routines.

### BACKGROUND

The television marketplace is a marketplace where many people in the same geographical region have different language preferences. Accordingly, televisions are typically sold with multilingual menu systems, and provide an on-screen menu that allows the user to select menus in one of several supported languages (such as English, Spanish, and French for the North American market). Many broadcasts have a main audio channel in a primary language and also contain one or more SAPs (Secondary Audio Programs) in secondary languages, and/or provide closed captioning in one or more languages. A television with the ability to decode these additional audio/text streams can be adjusted to a user's viewing preferences for audio channel and caption channel. The entry of digital video into the marketplace has, if anything, increased the available language possibilities.

### BRIEF DESCRIPTION OF THE DRAWING

The embodiments may be best understood by reading the disclosure with reference to the drawing, wherein:

FIG. 1 contains a block diagram for a digital television according to some embodiments of the present invention;

FIG. 2 shows messaging and routine calls to propagate language settings in an embodiment like that shown in FIG. 1;

FIG. 3 demonstrates the high-level tasks performed to select an other-than-default language for a Java applet according to some embodiments of the present invention;

FIG. 4 illustrates some embodiments for obtaining a string in a selected language for an applet display;

FIG. 5 contains a flowchart for saving a language option to a flash memory language option table; and

FIG. 6 contains a flowchart for retrieving a language option from a flash memory language option table.

### DETAILED DESCRIPTION OF THE EMBODIMENTS

The television embodiments described herein have an enhanced language configuration capability. A typical television allows one language setting for all menus and on-screen display messages, a single audio channel selection that is retained as a user moves between channels, and a single caption setting that is retained as a user moves between channels. The embodiments described below remove one or more of these restrictions, allowing a user to associate particular language preferences with individual: menus, applets, broadcast channels, or media selections. In some embodiments, individualized settings can be stored in nonvolatile memory and then later retrieved to automatically adjust audio and/or text to a user's preferences.

One use of the present invention is with a television that allows a user to run a variety of Java applets such as media and applet browsers, media players, timers, messaging, personal video recorders (PVRs), and games. When used with such a television, embodiments of the present invention can allow users to tailor selected applets to use other than the default language settings, with all others using the global default setting.

An applet or application can also be used in some embodiments to examine the television's current media source, channel, or program and determine from a stored list whether the user has audio/captioning preferences for that source, channel, or program different from the default settings. If different settings have been saved for that source, channel, or program, the different settings can be automatically made when the user tunes to that source, channel, or program. Thus some channels that are primarily broadcast in a foreign language can be set to SAP and English closed-captioning for an English-speaking user. Or, if a DVD device is integrated with or controllable from the television, the DVD device language preferences can be saved for individual DVDs. Similar preferences can be set on a by-program basis, either for broadcast programs or programs saved as media files on a media storage device. The applet can also observe a user's individual setting preferences and save them automatically without further input from the user.

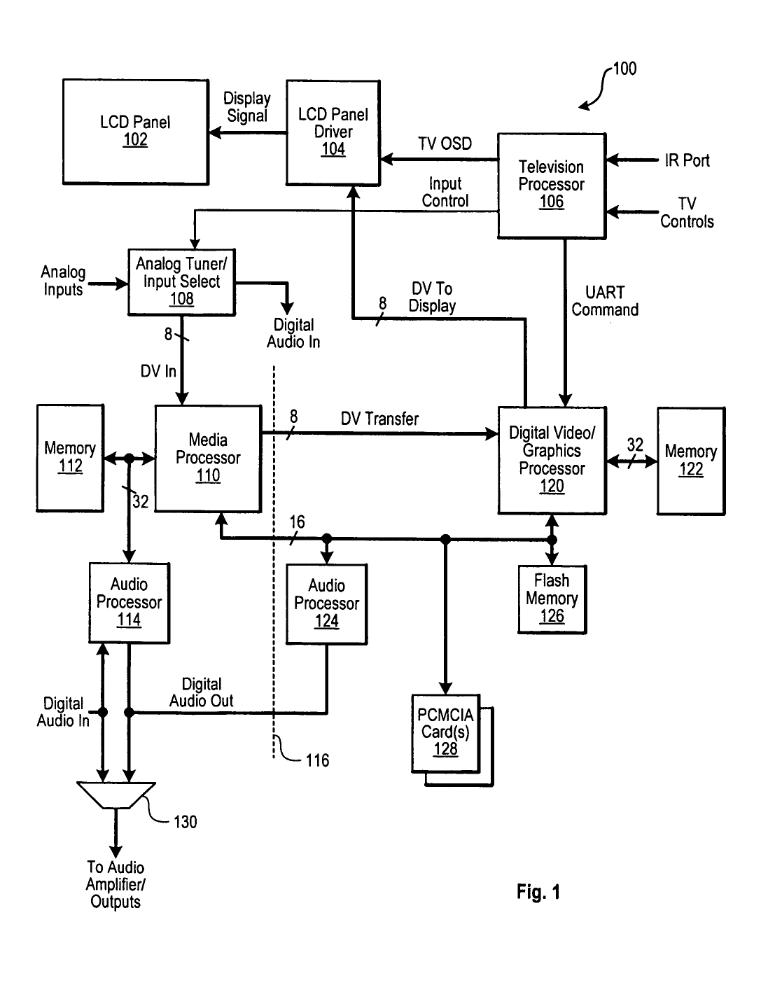

FIG. 1 contains a block diagram for a Liquid Crystal Display (LCD) television capable of operating according to some embodiments of the present invention. Television 100 contains an LCD panel 102 to display visual output to a viewer based on a display signal generated by an LCD panel driver 104. LCD panel driver 104 accepts a primary digital video signal in CCIR656 format (eight bits per pixel YC_{b}Cᵣ, in a “4:2:2” data ratio wherein two C_{b} and two Cᵣ pixels are supplied for every four luminance pixels) from a digital video/graphics processor 120.

A television processor 106 provides basic control functions and viewer input interfaces for television 100. Television processor 106 receives viewer commands, both from buttons located on the television itself (TV controls) and from a handheld remote control unit (not shown) through the IR Port. Based on the viewer commands, television processor 106 controls an analog tuner/input select section 108, and also supplies user inputs to the digital video/graphics processor 120 over a Universal Asynchronous Receiver/Transmitter (UART) command channel. Television processor 106 is also capable of generating basic On-Screen Display (OSD) graphics, e.g., indicating which input is selected, the current audio volume setting, etc. Television processor 106 supplies these OSD graphics, when activated, as a TV OSD signal to LCD panel driver 104 for overlay on the display signal.

Analog tuner/input select section 108 allows television 100 to switch between various analog (or possibly digital) inputs for both video and audio. Video inputs can include a radio frequency (RF) signal carrying standard broadcast television, digital television, and/or high-definition television signals, NTSC video, S-Video, and/or RGB component video inputs, although various embodiments may not accept each of these signal types or may accept signals in other formats (such as PAL). The selected video input is converted to a digital data stream, DV In, in CCIR656 format and supplied to a media processor 110.

Analog tuner/input select section 108 also selects an audio source, digitizes that source if necessary, and supplies that digitized source as Digital Audio In to an audio processor 114 and a multiplexer 130. The audio source can be selected—independent of the current video source—as the audio channel(s) of a currently tuned RF television signal, stereophonic or monophonic audio connected to television 100 by audio jacks corresponding to a video input, or an internal microphone.

Media processor 110 and digital video/graphics processor 120 provide various digital feature capabilities for television 100, as will be explained further in the specific embodiments below. In some embodiments, processors 110 and 120 can be TMS320DM270 signal processors, available from Texas Instruments, Inc., Dallas, Tex. Digital video/graphics processor 120 functions as a master processor, and media processor 110 functions as a slave processor. Media processor 110 supplies digital video, either corresponding to DV In or to a decoded media stream from another source, to digital video/graphics processor 120 over a DV transfer bus.

Media processor 110 performs MPEG (Motion Picture Expert Group) coding and decoding of digital media streams for television 100, as instructed by digital video/graphics processor 120. A 32-bit-wide data bus connects memory 112, e.g., two 16-bit-wide×1M synchronous DRAM devices connected in parallel, to processor 110. An audio processor 114 also connects to this data bus to provide audio coding and decoding for media streams handled by media processor 110.

Dotted line 116 divides the media processor subsystem from the host processor subsystem. Media processor 110 cannot directly access the devices on the right (host) side of dotted line 116. Digital video/graphics processor 120 can access media processor 110 and memory 112 directly, however, and thus indirectly provides connectivity between media processor 110 and flash memory 126 or PCMCIA cards 128.

Digital video/graphics processor 120 coordinates (and/or implements) many of the digital features of television 100. A 32-bit-wide data bus connects memory 122, e.g., two 16-bit-wide×1M synchronous DRAM devices connected in parallel, to processor 120. A 16-bit-wide system bus connects processor 120 to media processor 110, an audio processor 124, flash memory 126, and ports for removable PCMCIA cards 128. Flash memory 126 stores boot code, configuration data, system executable code, and Java code/class files for graphics applications and applets, etc.

Removable device ports for PCMCIA cards 128 can provide extended media and/or application capability for the television, such as the Java applets or stored media files mentioned herein. In some embodiments, the removable device port comprises one or two PCMCIA (Personal Computer Memory Card International Association) PC card ports. The PC card and its ports are described in a series of standards dating back to the 1980s—see, for instance, PC Card Standard 8.0 Release—April 2001. The PC card interface was developed for laptop computers and other computers that do not provide the large internal card bays (e.g., for Peripheral Component Interconnect cards) of desktop and tower servers. PC cards manufactured today provide Ethernet network interfaces, modems, wireless network interfaces (e.g., IEEE 802.11x), mass storage with micro disk drives or flash memory (CompactFlash), and CompactFlash adapters for other flash formats such as Memory Stick, MultiMedia Card, Secure Digital, SmartMedia, and XD. In some embodiments, applets or media files can be provided to the television by loading the applets or media files to a mass storage device, e.g., from a computer, or purchasing a mass storage device with the applets or media files preloaded, and then connecting the mass storage device to the PC card port. Alternately, with a wireless network interface card inserted in the PCMCIA port, applets or media files stored on a personal computer on the same wireless network can be accessed at the television. Additionally, the television may accept and support other PCMCIA-compatible devices.

Digital video/graphics processor 120 can pass data from the DV Transfer bus to LCD panel driver 104 as is, but processor 120 can also supercede, modify, or superimpose the DV Transfer signal with other content. For instance, processor 120 can generate Java application/applet graphics that overlay or supercede the DV Transfer signal, system graphics that display messages over all underlying content, or decode media from PCMCIA cards 128, e.g., in a “time-shifting” mode where media processor 110 is coding a program to the PCMCIA card and processor 120 decodes and displays a time-shifted version of the same program, allowing the viewer to pause, rewind, or skip through the program.

Multiplexer 130 provides audio output to the television amplifier and line outputs (not shown) from one of three sources. The first source is the current Digital Audio In stream from analog tuner/input select section 108. The second and third sources are the Digital Audio Outputs of audio processors 114 and 124. These two outputs are tied to the same input of multiplexer 130, since each audio processor is capable of tri-stating its output when it is not selected. In some embodiments, processors 114 and 124 can be TMS320VC5416 signal processors, available from Texas Instruments, Inc., Dallas, Tex.

At system powerup, digital video/graphics processor 120 creates an executable image for itself in memory 122 and for media processor 110 in memory 112. Flash memory 126 stores the elements of this image as default system code for processors 110, 114, 120, and 124. This code includes: a system manager, a Java engine, which may contain any combination of a just-in-time Java compiler, a Java interpreter, or precompiled Java code, and a Java manager that manages Java applets for processor 120; audio codecs for processors 114 and 124; and video codecs for processors 110 and 120. The system manager provides low-level functions for communication with the other devices attached to processor 120, and communicates system events to the Java manager and other processes. The Java engine interprets and executes Java code for the Java manager, and Java applets when applets are loaded.

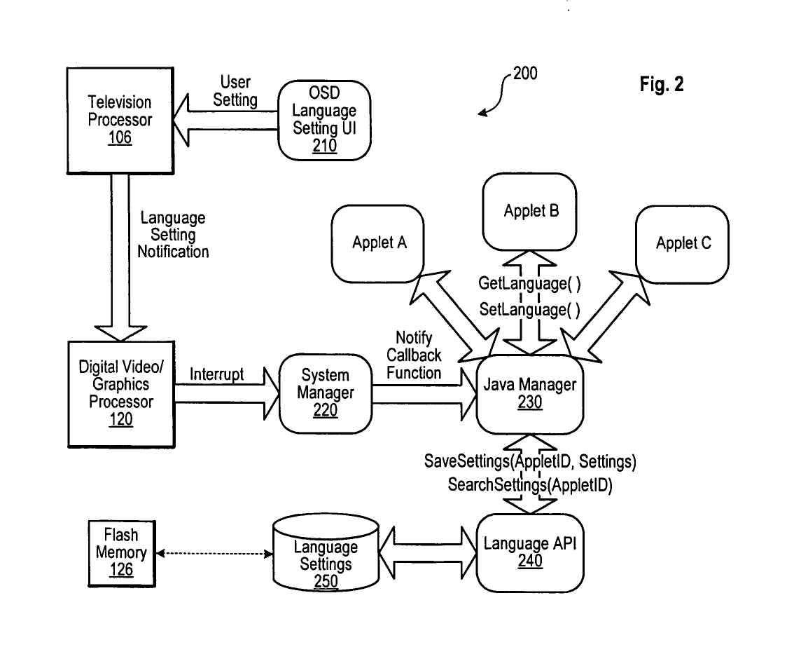

FIG. 2 shows messaging and routine calls to propagate language settings in a platform like that shown in FIG. 1. The television processor 106 has the capability to run an On-Screen Display (OSD) language-setting user interface 210 that can be invoked with a television remote control. User interface 210 allows the user to choose between several preset languages for the OSD menu. When the user selects and confirms one of these preset languages, it affects the OSD menus, and also generates a language-setting notification from television processor 106 to digital video/graphics processor 120. The notification interrupts the current process running on processor 120, and an interrupt service routine (ISR) within a system manager 220 invokes a callback function registered by a Java manager 230. The callback function notifies Java manager 230 that a new default language setting has been confirmed by the viewer. Registered applets (e.g., applets A, B, and C in FIG. 2) receive a software callback notifying them of the default language setting. The language setting is also written to a Java constant that applets can access using TvServiceProxy.GetLanguage( ). This mechanism will set the default language across the platform, and guarantees the integrity of the language setting.

In some embodiments, individual applets can use language settings that differ from the default language setting. For example, the Java engine can provide a language API 240 that allows an applet (or an applet language manager in Java manager 230) to save language settings (e.g., SaveSettings(AppletID, Settings)) and find previously saved language settings (e.g., SearchSettings(AppletID)). Language API can in some embodiments maintain a language settings file 250 in flash memory 126, as will be explained in detail below.

Several different programming methods can be provided to provide a user interface that allows a viewer to custom-tailor the language settings for a particular applet. In one approach, a global language manager class can be provided in Java manager 230, which contains an application manager class that allows the viewer to manage and launch applets. When the user navigates to an applet in the application manager, one option can enter the language manager and allow the viewer to provide language settings for the selected applet.

Another approach is to provide APIs that an applet can choose to call to allow language setting. Such an API could allow the applet to specify the language options available for that applet, as some applets could have different language options than others.

Each applet can also be responsible for providing its own language user interface and save the setting with the class.

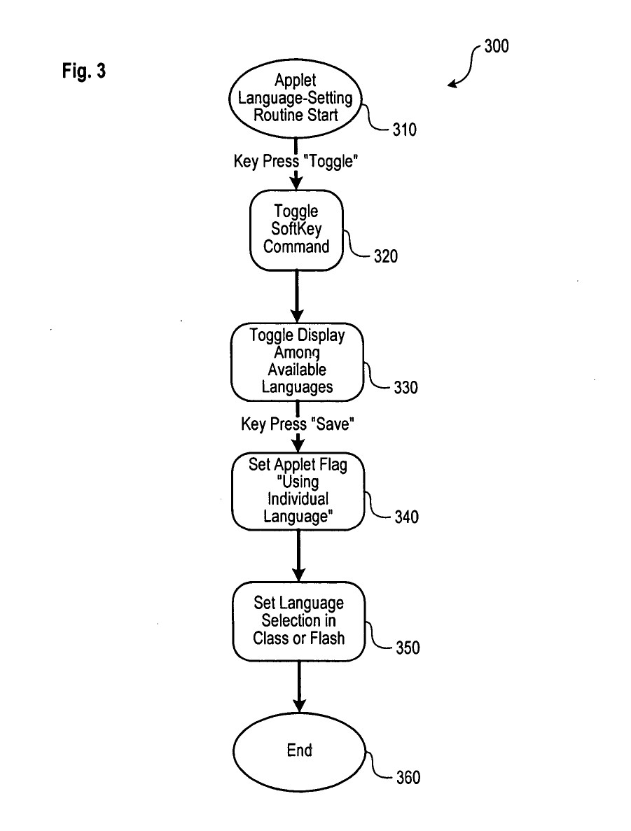

No matter what approach is used to provide language customization, FIG. 3 shows an exemplary procedure 300 for customizing language settings beyond the default global setting described above. An applet language-setting routine is entered at point 310 and a set of language options are displayed to the user. The user presses navigation/select keys on the remote that correspond to a toggle or select command. The keypress events propagate through the system manager and Java engine and result in the notification of the events to the Java application or applet with focus. A toggle softkey command process 320 interprets the keypress and changes the current language selection accordingly. Process 330 provides feedback to the user by toggling the display in response to the user input. In a three-language system, for instance, toggle states can exist for each of the three language and for a “global” or “default” setting that will track and use the global platform setting. The set of toggle states can be fixed, can differ for individual applets, or can be supplied as arguments to the setting routine. The user may perform more than one of these language selection operations, and will eventually either have to cancel or save the new settings. Assuming the user selects a softkey associated with “save,” process 340 will set an applet flag corresponding to the option “Using Individual Language.” When the “global” setting was selected, “Using Individual Language” will be set to false; otherwise, “Using Individual Language” will be set to true. Finally, when an individual language is selected, process 350 sets the last-selected language selection, either in the applet class or in a flash memory language setting structure, depending on the method chosen. When the global setting is selected, process 350 can choose to leave a previous but now unused setting in place or remove it.

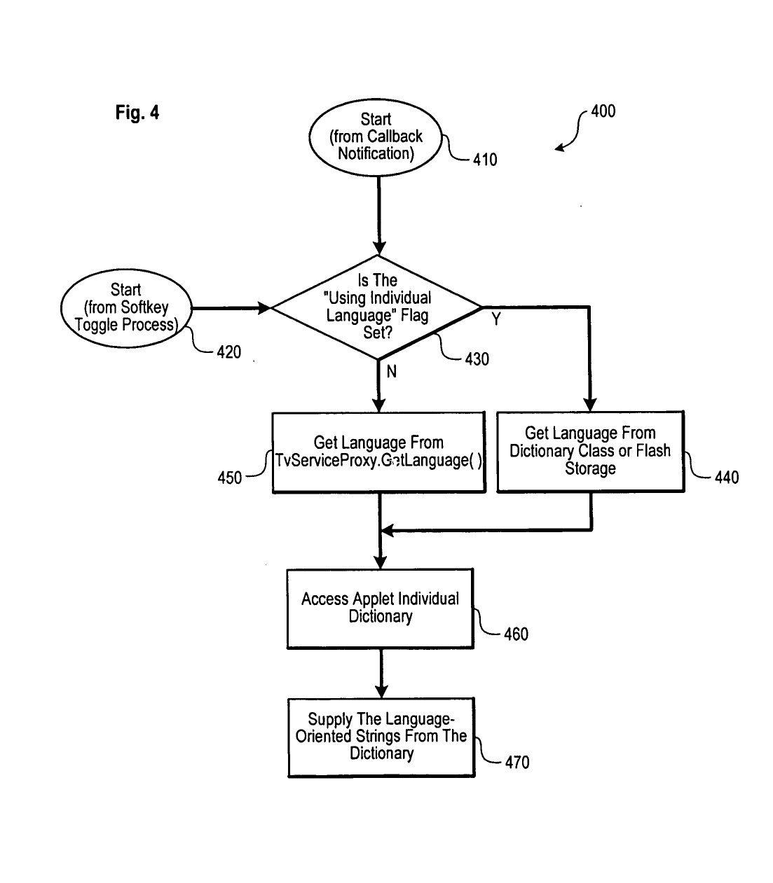

FIG. 4 illustrates a process 400 for obtaining strings in a selected language for an applet display. Process 400 can be prompted from a callback notification 410 when the user modifies the global language settings, as described in conjunction with FIG. 2 above. Process 400 can also be prompted by the softkey toggle process 300 described in conjunction with FIG. 3 above. In each case, block 430 examines the “Using Individual Language” flag for the applet. When the flag is set, process 440 obtains the current language setting, either from the dictionary class or from flash storage, depending on the method used. When the flag is not set, process 450 obtains the current global language setting from TvServiceProxy.GetLanguage( ). Block 460 then uses the language setting to access the applet's dictionary, and block 470 supplies language-oriented strings from the dictionary for use by the applet.

Some embodiments utilize nonvolatile memory, such as flash memory 126 in FIG. 1, to store individual language selection entries. For each applet, if it is configured to use individual language settings for its operation, a [JAD, language option ID] pair is stored into the flash device. Each JAD (Java Applet Descriptor) is unique to a particular applet and is used by the application manager to launch that applet. The language option ID is one of a set of enumerated language identifiers and is preferably consistent across the television platform.

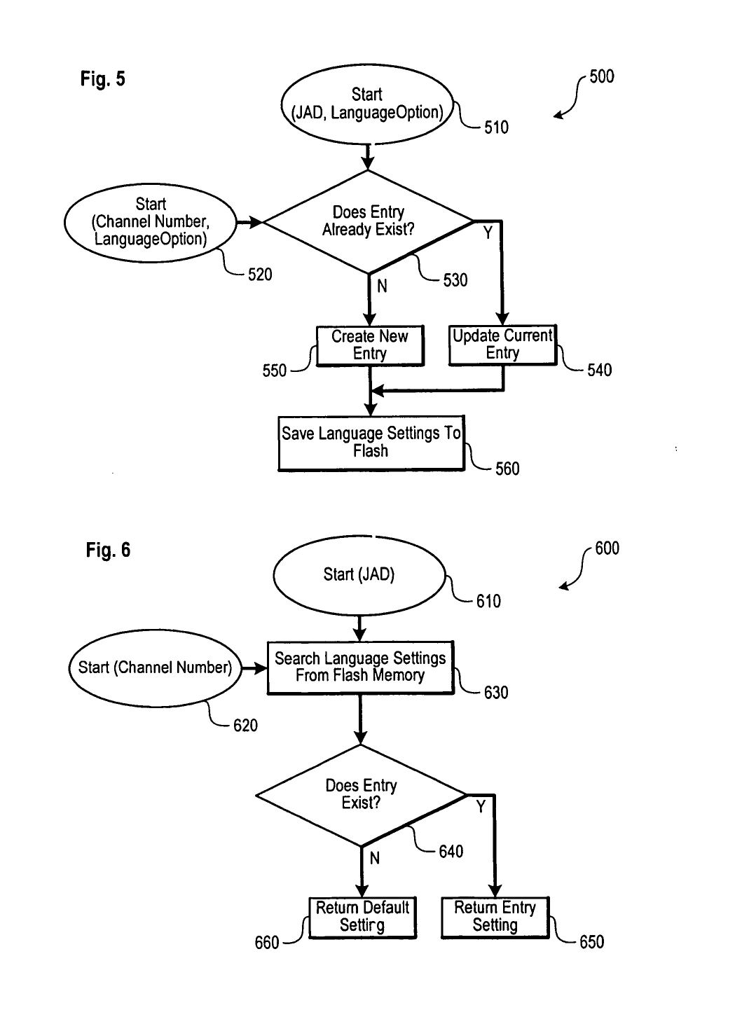

In the description of FIG. 2, two Java engine processes SaveSettings(AppletID, Settings) and SearchSettings(AppletID) were described that each access a language settings file 250 stored in flash memory 126. FIGS. 5 and 6 illustrate exemplary implementations of these processes. FIG. 5 shows a language option SaveSettings process 500. Process 500 can be invoked at point 510 from a Java applet or the Java manager by supplying the applet's JAD and a LanguageOption. Decision block 530 searches the saved language settings for entries matching the submitted JAD. If such an entry is found, block 540 updates the entry with the new LanguageOption. If no entry for the submitted JAD exists, block 550 creates a new entry for the JAD, LanguageOption pair. Block 560 saves the language settings to flash memory. Note that block 560 can execute immediately, or the language settings can be retained in system memory and saved periodically.

FIG. 6 shows a companion SearchSettings process 600. Process 600 can be invoked at point 610 from a Java applet or the Java manager by supplying the applet's JAD. Process 600 will typically be invoked when the applet is first invoked by the application manager. This initialization can be done by either the application manager during applet invocation, or by the applet as soon as the applet's init( ) function is invoked by the application manager. When process 600 is entered, the supplied JAD parameter is used in block 630 to search language settings from the flash memory. Decision block 640 branches based on whether an entry was found or not. If found, block 650 returns the LanguageOption read from the language settings entry for the supplied JAD parameter. If no entry was found, block 660 returns a default setting value, indicating that the flag “Using Individual Language” should be unset for the applet.

FIGS. 5 and 6 show two additional entry points 520 and 620, respectively. These entry points can be used to store and retrieve other individual language settings from flash memory. These entry points can be used by the Java manager or a Java applet to store and retrieve language settings for entities other than applets. For instance, many digital media streams contain multiple languages in the audio stream, and/or multiple closed captions in different languages. A user may wish to save particular spoken/captioned settings for particular broadcast channels or programs. When the user changes settings, they can be prompted as to whether the settings should be remembered for the current channel or program. If the user answers “yes,” the Java manager can invoke an API to discover the current channel and/or program and create a meaningful pairing such as (Channel Number, LanguageOption). This pairing can be saved in the same fashion that pairings are saved for applets.

When the user tunes a channel, the Java manager can receive a callback notifying it of the channel change. An applet or class can respond to the callback by entering process 600 at node 620 with the channel number as an argument. If an individual entry is returned for the channel, the applet or class can select the audio stream and/or captioning as required to conform to the user's preferences for that channel.

The function need not be associated with every channel, but perhaps with favorite channels accessible through “fast tuning” buttons on the remote.

The same type of function can be used to set which audio stream is recorded when the television is functioning in a PVR (Personal Video Recorder) mode. Language preferences can also be associated with stored media streams, such as those stored on a PVR, a DVD, or a computer accessible by the television.

One of ordinary skill in the art will recognize that the concepts taught herein can be tailored to a particular application in many other advantageous ways. In particular, those skilled in the art will recognize that the illustrated embodiments are selected from many alternative implementations that will become apparent upon reading this disclosure. For instance, although Java applets have been described, the described embodiments can be used with other coding schemes and with any type of television entity that might have multiple language possibilities. Such minor modifications are encompassed within the embodiments of the invention, and are intended to fall within the scope of the claims.

The preceding embodiments are exemplary. Although the specification may refer to “an”, “one”, “another”, or “some” embodiment(s) in several locations, this does not necessarily mean that each such reference is to the same embodiment(s), or that the feature only applies to a single embodiment.

1. A television receiver comprising:
a user interface to allow a user to specify a language selection and associate that language selection with selected viewable content;
a digital memory to store the association between the language selection and the viewable content selection; and
a digital processor configured to search associations stored in the digital memory when viewable content is selected, and to configure the television receiver according to a stored language selection when a stored language selection is associated with the viewable content.

2. The television receiver of claim 1, wherein the viewable content is selected from the group of viewable contents including stored video, television channels, television programs, television applets, and combinations thereof.

3. The television receiver of claim 1, wherein the language selection can refer to an audio channel, a caption channel, an applet dictionary, an applet class, and combinations thereof.

4. The television receiver of claim 1, further comprising a global language association, the digital processor configuring the television receiver according to the global language association when no stored language selection is associated with the viewable content.

5. The television receiver of claim 1, further comprising a television processor to receive user input and generate an on-screen display, the television processor notifying the digital processor when user input is received.

6. The television receiver of claim 1, wherein the digital processor is configured to create at least some of the viewable content by running applets stored in the digital memory.

7. A method of operating a television receiver, the method comprising:
interfacing with a user to allow the user to make multiple associations between a language selection and viewable content;
when a user makes an association between a language selection and viewable content, storing the association in a digital memory; and
when a user selects viewable content, searching the associations stored in the digital memory for an association between that viewable content and a language selection, and, when such an association is found, configuring the television receiver according to the found association.

8. The method of claim 7, wherein interfacing with a user comprises displaying, on the television receiver to a user, languages available for association with specific viewable content, and permitting the user to toggle the display between the available languages and identify an available language for association with the specific viewable content.

9. The method of claim 8, wherein interfacing with a user comprises running a language-selection applet that can be called from viewable-content applets.

10. The method of claim 7, further comprising:
interfacing with the user to allow the user to set a default platform language; and
configuring the television receiver to use the default platform language when selected viewable content has no stored association with a language selection.

11. The method of claim 7, wherein storing the association to memory comprises searching the associations stored in the digital memory for a previous association identified with the selected viewable content, and, when a previous association is found, replacing the previous association with the user association.

12. The method of claim 7, wherein storing the association to memory comprises writing the association to a non-volatile memory.

13. The method of claim 7, wherein configuring the television receiver according to the found association comprises selecting a string dictionary corresponding to the language selection and the viewable content, and supplying elements from that string dictionary to an applet responsible for creating the viewable content.

14. The method of claim 7, wherein the viewable content comprises a television applet.

15. The method of claim 7, wherein the viewable content is selected from the group of viewable contents including stored video, television channels, television programs, television applets, and combinations thereof.

16. The method of claim 7, wherein the language selection can refer to an audio channel, a caption channel, an applet dictionary, an applet class, and combinations thereof.

17. An apparatus comprising a computer-readable medium containing computer instructions that, when executed on a processor, cause the processor to implement a method of operating a television receiver, the method comprising:
interfacing with a user to allow the user to make multiple associations between a language selection and viewable content;
when a user makes an association between a language selection and viewable content, storing the association in a digital memory; and
when a user selects viewable content, searching the associations stored in the digital memory for an association between that viewable content and a language selection, and, when such an association is found, configuring the television receiver according to the found association.

18. The apparatus of claim 17, wherein interfacing with a user comprises displaying, on the television receiver to a user, languages available for association with specific viewable content, and permitting the user to toggle the display between the available languages and identify an available language for association with the specific viewable content.

19. The apparatus of claim 18, wherein interfacing with a user comprises running a language-selection applet that can be called from viewable-content applets.

20. The apparatus of claim 17, the method further comprising:
interfacing with the user to allow the user to set a default platform language; and
configuring the television receiver to use the default platform language when selected viewable content has no stored association with a language selection.

21. The method of claim 17, wherein storing the association to memory comprises searching the associations stored in the digital memory for a previous association identified with the selected viewable content, and, when a previous association is found, replacing the previous association with the user association.

22. The method of claim 17, wherein storing the association to memory comprises writing the association to a non-volatile memory.

23. The method of claim 17, wherein configuring the television receiver according to the found association comprises selecting a string dictionary corresponding to the language selection and the viewable content, and supplying elements from that string dictionary to an applet responsible for creating the viewable content.

24. The method of claim 17, wherein the viewable content comprises a television applet.

25. The method of claim 17, wherein the viewable content is selected from the group of viewable contents including stored video, television channels, television programs, television applets, and combinations thereof.

26. The method of claim 17, wherein the language selection can refer to an audio channel, a caption channel, an applet dictionary, an applet class, and combinations thereof.
